(19) United States
(12) Patent Application Publication
(10) Pub. No.: US 2009/0060368 A1
(43) Pub. Date: Mar. 5, 2009

(54) Method and System for an Adaptive HVS Filter

(76) Inventors: David Drezner, Raanana (IL); Yehuda Mittelman, Yokneam (IL)

Correspondence Address: MCANDREWS HELD & MALLOY, LTD, 500 WEST MADISON STREET, SUITE 3400, CHICAGO, IL, 60661, US

(21) Appl. No.: 11/845,336

(22) Filed: Aug. 27, 2007

(51) Int. Cl. G06K 9/40

(52) U.S. Cl. 382/261

(57) ABSTRACT

Methods and systems for an adaptive HVS filter are disclosed. Aspects of one method may include generating standard quantized coefficients and filtering coefficients during processing of video data. The standard quantized coefficients may be filtered by utilizing the corresponding filtering coefficients. A filtering matrix comprising the filtering coefficients may be generated using one of a plurality of adaptive quantization matrices. Each of the adaptive quantization matrices may be generated based on, for example, a texture of a portion of the video data being processed. The adaptive quantization matrix for generating the filtering coefficients may be selected for each macroblock, or for each block in a macroblock, in the video data. The value of a standard quantized coefficient may be set to a zero when the corresponding filtering coefficient is zero. The original value of a standard quantized coefficient may be used as is when the corresponding filtering coefficient is non-zero.

### CROSS-REFERENCE TO RELATED APPLICATIONS/INCORPORATION BY REFERENCE

[Not Applicable.]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to signal processing. More specifically, certain embodiments of the invention relate to a method and system for an adaptive HVS filter.

### BACKGROUND OF THE INVENTION

In video system applications, a picture is displayed on a television or a computer screen by scanning an electrical signal horizontally across the screen one line at a time using a scanning circuit. The video signals may be communicated to the display monitor, for example, for a television or for a computer, via over-the-air transmission, cable transmission, and/or the internet. To maximize throughput for a given amount of channel spectrum, the video signals may be compressed. Generally, while there are lossy and non-lossy compression algorithms, many video compression algorithms tend to be lossy to reduce compressed video file size. A lossy algorithm such as a block based motion compensation scheme (used by MPEG, for example) is a common lossy video compression algorithm. In lossy compression, the trade-off may be the amount of compression (target bit rate) versus the quality of the decompressed video signals. The quality measurement may be set by an “objective human observer,” where the objective human observer is set as a statistical expectation measurement of a large number of subjective human observers with correlated scores.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for an adaptive HVS filter, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is an exemplary diagram of a portion of a video system, which may be utilized in connection with an embodiment of the invention.

FIG. 1B is an exemplary block diagram for coding MPEG2 INTRA frames using adaptive HVS filtering, in accordance with an embodiment of the invention.

FIG. 1C is an exemplary block diagram for coding MPEG2 INTER frames using adaptive HVS filtering, in accordance with an embodiment of the invention.

FIG. 1D is an exemplary block diagram for coding frames using AVC (MPEG4-part-10 or ITU-H264) technology with adaptive HVS filtering, in accordance with an embodiment of the invention.

FIG. 2A is an exemplary diagram illustrating a pixel block, which may be utilized in connection with an embodiment of the invention.

FIG. 2B is an exemplary diagram illustrating zig-zag scan of a pixel block, which may be utilized in connection with an embodiment of the invention.

FIG. 3 is an exemplary flow diagram for using an adaptive HVS filter, in accordance with an embodiment of the invention.

### DETAILED DESCRIPTION OF THE INVENTION

Certain embodiments of the invention may be found in a method and system for an adaptive human visual system (HVS) filter. Aspects of the method may comprise generating standard quantized coefficients and filtering coefficients during processing of video data. The standard quantized coefficients may be filtered by utilizing the corresponding filtering coefficients. The adaptive quantization matrix for generating the filtering coefficients may be selected for each macroblock, or for each block in a macroblock, in the video data. The value of a standard quantized coefficient may be set to a zero when the corresponding filtering coefficient is zero. The original value of a standard quantized coefficient may be used when the corresponding filtering coefficient is non-zero.

A filtering matrix comprising the filtering coefficients may be generated using one of a plurality of adaptive quantization matrices. Each of the adaptive quantization matrices may be generated based on, for example, a texture of a portion of the video data being processed. The texture of video data may comprise luminance and/or chrominance of pixels in the portion of the video data being processed. The adaptive quantization matrices may also be generated based on the video data, input noise level of the video data, a scan type of the video data, target bit rate, picture resolution, macroblock motion vector, pixel block motion vector, motion correlation to surrounding macroblocks, and/or motion correlation to surrounding pixel blocks.

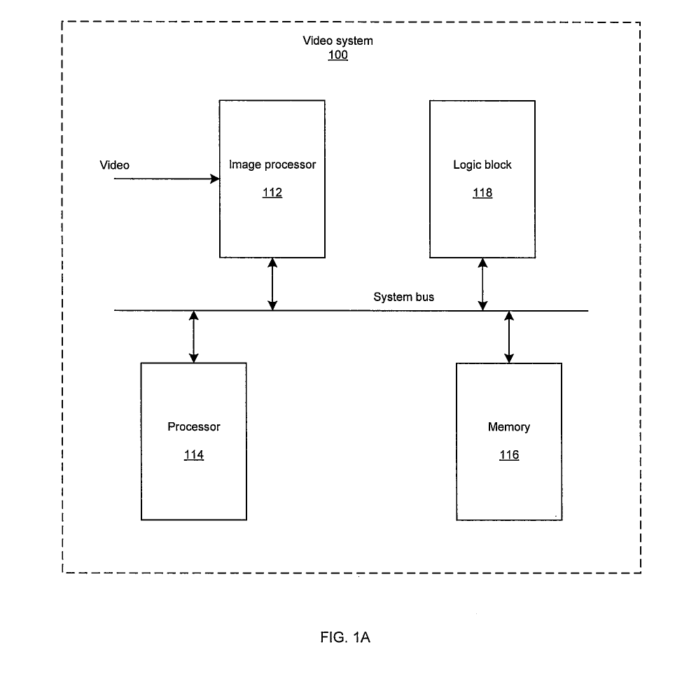

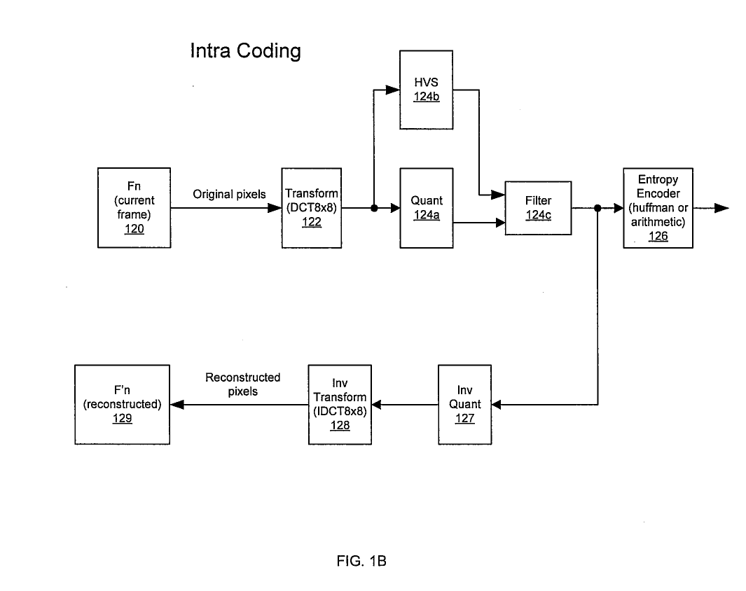

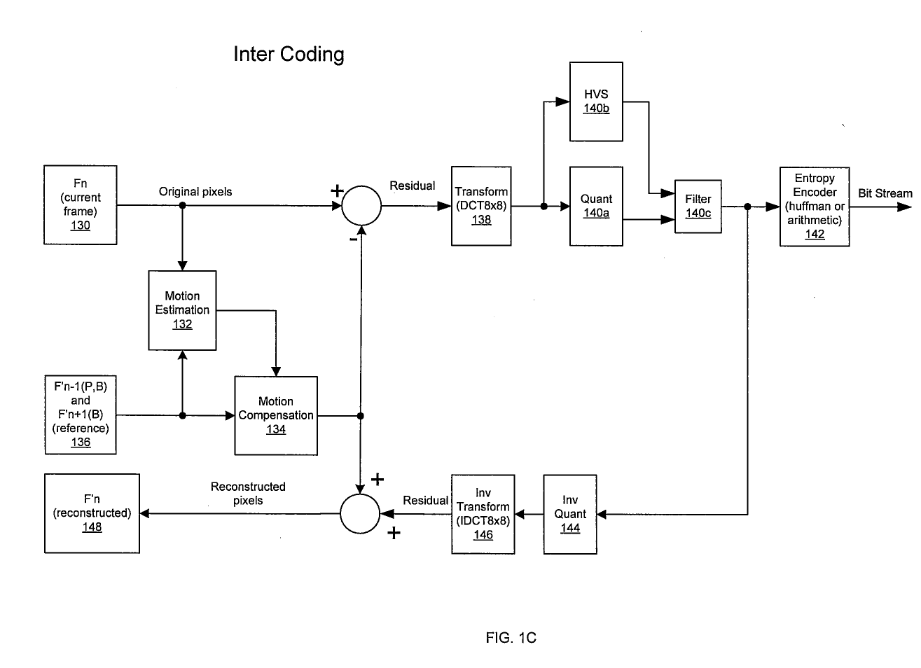

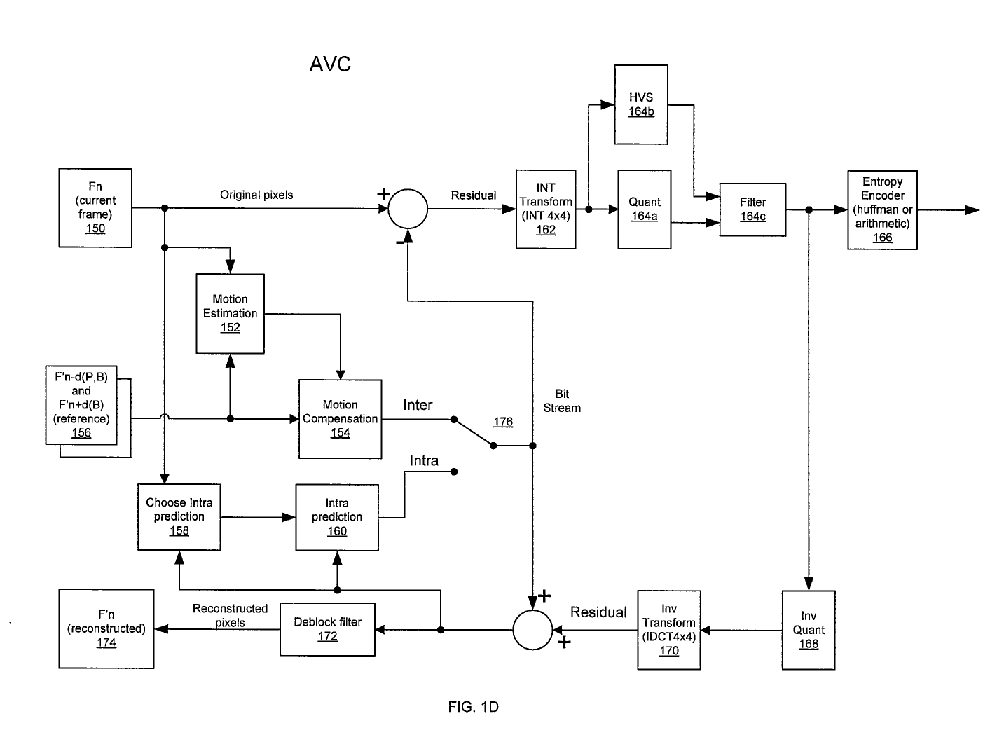

FIG. 1A is an exemplary diagram of a portion of a video system, which may be utilized in connection with an embodiment of the invention. Referring to FIG. 1A, there is shown a video system 100. The video system 100 may comprise an image processor 112, a processor 114, a memory block 116, and a logic block 118. The image processor 112 may comprise suitable circuitry and/or logic that may enable processing of video data. The image processor block 112 may perform, for example, a discrete cosine transform (DCT) to video data in blocks of 8×8 pixels. The video data may be processed, for example, for display on a monitor, or encoded for transfer to another device.

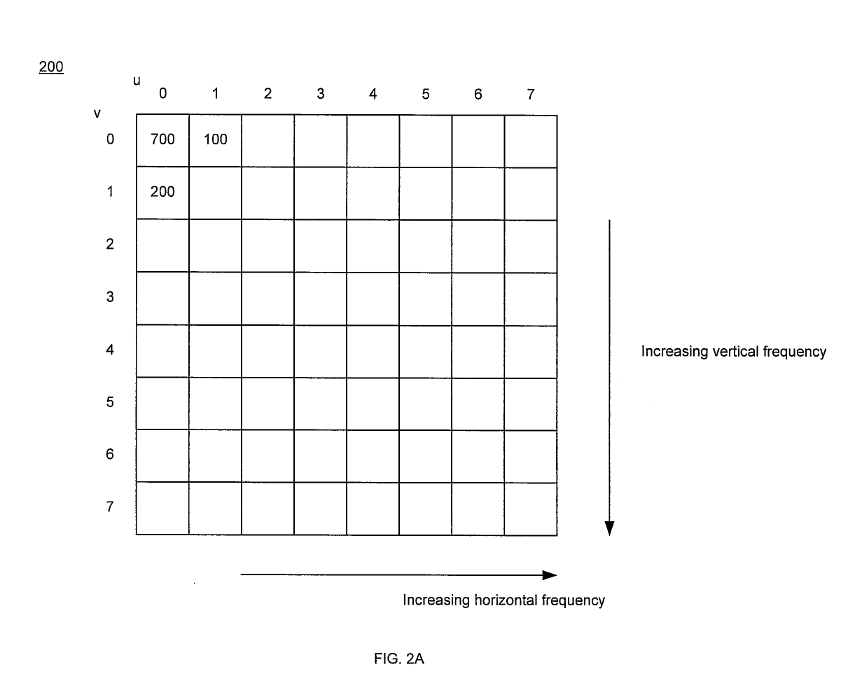

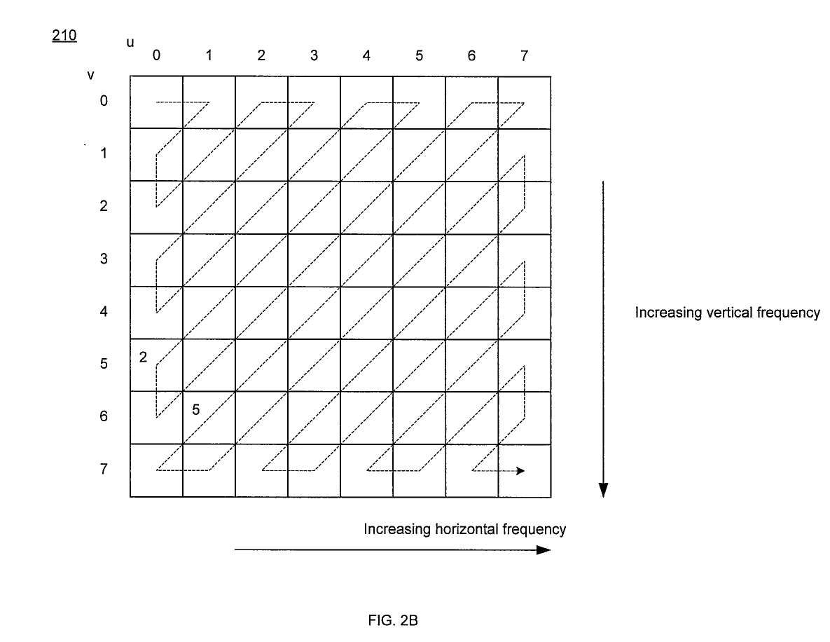

For example, the video system 100 may be a part of a computer system that may compress the video data in video files for transfer via the Internet. Similarly, the video system 100 may encode video for transfer to, for example, a set-top box, which may then decode the encoded video for display by a television set. Video data may be processed to remove, for example, redundant information and/or information that may not be noticed by viewers. For example, when video data is processed using block based video compression, such as, for example, MPEG compression, discrete cosine transform (DCT) may be used. The video compression may optimize data, as possible, to increase the number of sequential coefficients that may be zeros—thus reducing entropy. In this manner, an encoding algorithm may be able to encode the string of zeros more efficiently than if the coefficients are not sequential zeros. For example, the encoding may comprise a number that indicates the number of coefficients, and a value of the coefficient. This may require less data than if a coefficient value was enumerated for each coefficient. This is discussed in more detail with respect to FIG. 2B.

The processor 114 may determine the mode of operation of various portions of the video system 100. For example, the processor 114 may configure data registers in the image processor block 112 to allow direct memory access (DMA) transfers of video data to the memory block 116. The processor may also communicate instructions to the image sensor 110 to initiate capturing of images. The memory block 116 may be used to store image data that may be processed and communicated by the image processor 112. The memory block 116 may also be used for storing code and/or data that may be used by the processor 114. The memory block 116 may also be used to store data for other functionalities of the video system 100. For example, the memory block 114 may store data corresponding to voice communication. The logic block 118 may comprise suitable logic and/or code that may be used for video processing. For example, the logic block 118 may comprise a state machine that may enable execution and/or control of data compression.

In operation, a video encoder, which may be, for example, an MPEG2 encoder and/or an MPEG4 encoder, and may be part of the image processor 112, may encode a sequence of pictures. The MPEG2 encoder may encode in two complementary methods: coding for INTRA mode and coding for INTER mode. INTRA mode may remove spatial information redundancy and INTER mode may remove both temporal and spatial redundancy information. If all the blocks of a video frame are coded in INTRA mode (I-pictures or I-frames), then each I-frame may comprise all the information needed to display that frame.

INTER blocks may comprise information that indicate the difference between the present frame and the previous temporal frame and/or the next temporal frame. P-frames or B-frames may include INTER coded macroblocks, and also INTRA macroblocks, where a macroblock may be a block of 16×16 pixels. A P-frame is encoded with respect to information in the previous frame. Each macroblock in a P-frame may be encoded as an I-macroblock or a P-macroblock. A B-frame may be uni-directional or bi-directional temporal prediction. That is, a B-frame may be encoded based on a previous reference frame or a future reference frame, or both a previous reference frame and a future reference frame.

Accordingly, quantization may be different for INTER and INTRA coding modes. Additionally, quantization may be different for the AC and DC coefficients in the INTER/INTRA macroblocks. Exemplary coding of MPEG2 INTRA block using adaptive HVS filtering is illustrated in FIG. 1B, and exemplary coding of MPEG2 INTER block using adaptive HVS filtering is illustrated in FIG. 1C. The AVC may also use INTER and INTRA blocks. FIG. 1D illustrates an exemplary block diagram for coding using AVC technology with adaptive HVS filtering.

The image processor block 112 may perform, for example, a discrete cosine transform (DCT) to video data in blocks of 8×8 pixels. The video data may be part of a video file, for example. The result may comprise DCT coefficients for the 8×8 block. The top-left hand coefficient may be the DCT coefficient for a DC value, and the remaining coefficients may comprise AC values where the frequencies may increase to the left and to the downward direction. This is illustrated in FIG. 2A.

The DCT coefficients may be compressed to generate smaller video files. For efficient compression, it may be desirable to scan the DCT coefficients in the blocks to maximize the number of sequential zeros. An exemplary scanning algorithm that may be used to optimize the number of sequential zeros may be a zig-zag scan, which is illustrated with respect to FIG. 2B.

FIG. 1B is an exemplary block diagram for coding MPEG2 INTRA frames using adaptive HVS filtering, in accordance with an embodiment of the invention. Referring to FIG. 1B, there is shown buffers 120 and 129, a DCT transform block 122, a standard quantizer block 124a, an adaptive HVS quantizer block 124b, a combining filter block 124c, an entropy encoder block 126, an inverse quantizer block 127, and an inverse transform block 128.

The buffer 120 may comprise suitable logic and/or circuitry that may be enabled to hold original pixels of a current picture and the DCT transform block 122 may comprise suitable logic, circuitry, and/or code that may be enabled to perform DCT transform of the original pixels. The standard quantizer block 124a may comprise suitable logic., circuitry, and/or code that may be enabled to quantize the coefficients from the DCT transform block 122. The standard quantizer block 124a may quantize coefficients as described by, for example, MPEG2 standards. Accordingly, outputs of the standard quantizer block 124a may be referred to as standard quantized coefficients.

The adaptive HVS quantizer block 124b may comprise suitable logic, circuitry, and/or code that may enable quantizing the outputs of the DCT transform block 122. The output of the adaptive HVS quantizer block 124b may be a filtering matrix comprising filtering coefficients. The adaptive HVS quantizer block 124b may use an adaptive quantization matrix to generate the filtering coefficients for the filtering matrix. Determination of the coefficients for each of the adaptive quantizer matrices may be design dependent. The combining filter block 124c may comprise suitable logic, circuitry, and/or code that may enable correlating the quantized outputs of the adaptive HVS quantizer block 124b with corresponding quantized outputs of the standard quantizer block 124a to generate filtered outputs. Accordingly, the filtered outputs may comprise coefficients that correspond to the outputs of the standard quantizer block 124a and the outputs of the adaptive HVS quantizer block 124b. The entropy encoder block 126 may comprise suitable logic, circuitry, and/or code that may be enabled to encode the output of the combining filter block 124c.

The inverse quantizer block 127 may comprise suitable logic, circuitry, and/or code that may be enabled to perform operations to outputs of the combining filter block 124c to generate DCT coefficients that may correspond to, for example, the DCT coefficients generated by the DCT transform block 122. The inverse transform block 128 may comprise suitable logic, circuitry, and/or code that may be enabled to perform operations to outputs of the inverse quantizer block 127 to generate reconstructed pixels that may correspond to, for example, the pixels stored in the buffer 120.

In operation, the DCT transform block 122 may generate DCT coefficients of the video data in the buffer 120. The DCT coefficients may be communicated to the standard quantizer block 124a and to the adaptive HVS quantizer block 124b. The quantized coefficients generated by the standard quantizer block 124a may be filtered by the adaptive HVS quantizer block 124b and the combining filter block 124c. The filtering may be referred to as adaptive HVS filtering.

The AC INTRA quantization coefficients, which may be generated by, for example, the standard quantizer block 124a, may be described by the following equation:

$${QuantCoeffs}_{ [ i , j ]} = sign ( {Y}_{[ i , j ]} ) ( \frac{32 \cdot \vert {Y}_{[ i , j ] ]} \vert + {Round}_{ [ i , j ]}}{2 \cdot {Q}_{m [ i , j ]} {Q}_{p}} + \frac{3 \cdot Q p + 2}{4 \cdot Q p} ) \qquad ( 1 )$$

where Y_{[i,j]} may be the DCT transformed coefficients, Qₘ may be the quantization matrices coefficients, and Qₚ may be the quantization scale/parameter according to, for example, the ISO standard 13818-2 (MPEG2). The sign(X) may be “−1” if X is less than zero, and “1” otherwise. Round_{[i,j]} may be, for example, ½(Q_{m[i,j]}).

The DC INTRA quantization coefficients, which may also be generated by, for example, the standard quantizer block 124a, may be described by the following equation:

$$IntraDcQuantCoeffs = sign ( {Y}_{[ 0 , 0 ]} ) \cdot ( \frac{\vert {Y}_{[ 0 , 0 ] ]} \vert + {Round}_{D C}}{{Q}_{D C}} ) \qquad ( 2 )$$

Where Round_{DC} may be equal to ½(Q_{DC}), and Q_{DC} may be equal to (8/DC_prec). The DC_prec may be, for example, a precision parameter according to the ISO standard 13818-2 (MPEG-2).

The MPEG2 standard may specify that some parameters, such as, for example, the quantization matrices coefficients Qₘ may change for I-frames and not for B-frames or P-frames. Accordingly, the standard quantizer block 124a may use same parameters for many video frames. This may lead to inefficient compression. For example, a frame may comprise people looking at a waterfall. The macroblocks of pixels that correspond to the waterfall may be compressed in the same way as the faces of the people looking at the waterfall. However, the “objective human observer” may indicate that details of the water drops falling over the waterfall may not be as important as the details of the faces of the people looking at the waterfall. Accordingly, parameters chosen to keep details of the faces may not be as useful when applied to the waterfall.

The adaptive HVS quantizer block 124b may use, for example, similar equations as for the standard quantizer block 124a. For example, Equation (1) may describe generation of the coefficients for the adaptive quantization matrix by the adaptive HVS quantizer block 124b. However, the parameters for the equations may be changed more frequently to try to optimize the compression versus details important to the “objective human observer,” and hence, to a viewer in general. The adaptive HVS quantizer block 124b may use different adaptive quantization matrices comprising, for example, a plurality of coefficients Qₘ for different portions of a video frame. For example, various embodiments of the invention may allow the adaptive quantization matrix to be changed for each macroblock, while other embodiments of the invention may allow a change for each block of pixels within a macroblock. For example, a macroblock may comprise 4 blocks of 8×8 pixels or 16 blocks of 4×4 pixels. The various adaptive quantization matrices used may be, for example, pre-generated, and the specific coefficients of the adaptive quantization matrices may be design dependent.

In this manner, by using different adaptive quantization matrices for different macroblocks, for example, for macroblocks of pixels corresponding to the waterfall and for macroblocks of pixels corresponding to the faces of the people, more important video information may be kept while the less important video information may be further compressed. Various embodiments of the invention may also, for example, allow changing of adaptive coefficient matrices for each block in a macroblock.

The combining filter block 124c may compare the coefficients generated by the standard quantizer block 124a to the corresponding coefficients generated by the adaptive HVS quantizer block 124b. An exemplary embodiment of the invention may enable the combining filter block 124c to set to zero the coefficients from the standard quantizer block 124a where the corresponding coefficients generated by the adaptive HVS quantizer block 124b may be zero. Other coefficients from the standard quantizer block 124a, where the corresponding coefficients generated by the adaptive HVS quantizer block 124b may be non-zero, may be left to their original value.

Accordingly, the output of the combining filter block 124c may comprise at least as many zero coefficients as the output of the standard quantizer block 124a. The adaptive HVS quantizer block 124b and the combining filter block 124c may be used to further compress, or filter, the coefficients generated by the standard quantizer block 124a. If an adaptive quantization matrix is suitably chosen, the output of the combining filter block 124c may comprise more zeros than the output of the standard quantizer block 124a. Accordingly, the output of the entropy encoder block 126 may comprise fewer bits than if the adaptive HVS quantizer block 124b and the combining filter block 124c were not used.

The entropy encoder block 126 may scan the output of the combining filter block 124c using, for example, the zig-zag scan. The scanning is explained with respect to FIGS. 2A and 2B. The quantized coefficients output by the combining filter block 124c may also be communicated to the inverse quantizer block 127. The inverse quantizer block 127 may, for example, perform operations that may be an inverse of the operations in the standard quantizer bock 124a. Accordingly, the inverse quantizer block 127 may perform operations according to, for example, the ISO standard 13818-2 (MPEG2) for an inverse quantizer. The inverse quantizer block 127 may generate an approximation of the original DCT coefficients output by the DCT transform block 122. Accordingly, the output of the inverse quantizer block 127 may comprise, for example, DCT coefficients plus quantization noise. The output of the inverse quantizer block 127 may be communicated to the inverse DCT transform block 128. The inverse DCT transform block 128 may process the DCT coefficients generated by the inverse quantizer block 127 to reconstruct the pixels from the original video data in the buffer 120. The reconstructed pixels from the inverse transform block 128 may be stored, for example, in the buffer 129. The reconstructed pixels may be used, for example, for processing subsequent video frames.

FIG. 1C is an exemplary block diagram for coding MPEG2 INTER frames using adaptive HVS filtering, in accordance with an embodiment of the invention. Referring to FIG. 1C, there is shown buffers 130, 136, and 144, a motion estimation block 132, a motion compensation block 134, a DCT transform block 138, a standard quantizer block 140a, an adaptive HVS quantizer block 140b, a combining filter block 140c, an entropy encoder block 142, an inverse quantizer block 148, and an inverse transform block 146. The buffers 130, 136, and 144, the DCT transform block 138, the standard quantizer block 140a, adaptive HVS quantizer block 140b, a combining filter block 140c, the entropy encoder block 142, the inverse quantizer block 148, and the inverse transform block 146 may be similar to the corresponding blocks described in FIG. 1B.

The motion estimation block 132 may comprise suitable logic, circuitry, and/or code that may be enabled to estimate change in motion from one frame to another. The motion compensation block 134 may comprise suitable logic, circuitry, and/or code that may be enabled to provide compensation for estimated change in motion from one frame to another.

The buffer 130 may hold the original pixels of the current frame and the buffer 136 may hold reconstructed pixels of previous frames. An encoding method from, for example, MPEG standard, may use the motion estimation block 132 to process a block of 16×16 pixels in the buffer 130 and a corresponding block of pixels in the buffer 136 to find a motion vector for the block of 16×16 pixels. The block of 16×16 pixels may be referred to as a macroblock, for example. The motion vector may be communicated to the motion compensation block 134, which may use the motion vector to generate a motion compensated macroblock of 16×16 pixels from the reconstructed pixels stored in the buffer 136. The motion compensated macroblock of 16×16 pixels may be subtracted from the original pixels from the buffer 130, and the result may be referred to as residual pixels.

The residual pixels may be DCT transformed by the DCT transform block 138, and the resulting DCT coefficients may be quantized by the standard quantizer block 140a and by the adaptive HVS quantizer block 140b. The quantized coefficients from the standard quantizer block 140a and the adaptive HVS quantizer block 140b may be communicated to the combining filter block 140c. The output of the quantizer block 140c may be communicated to the entropy encoder 142 and the inverse quantizer block 148. The quantized coefficients from the standard quantizer block 140a may be filtered by the adaptive HVS quantizer block 140b and the combining filter block 140c. The entropy encoder block 142 may scan the quantized coefficients in, for example, a zig-zag scan order.

The quantized coefficients may be processed by the inverse quantizer block 148 and then by the inverse DCT transform block 146 to generate reconstructed residual pixels. The reconstructed residual pixels may be added to the motion compensated macroblock of 16×16 pixels from the motion compensation block 134 to generate reconstructed pixels, which may be stored in the buffer 144. The reconstructed pixels may be used, for example, to process subsequent video frames.

The INTER quantization, which may be performed by, for example, the standard quantizer block 140a, may be described by the following equation:

$${QuantCoeffs}_{ [ i , j ]} = sign ( {Y}_{[ i , j ]} ) ( \frac{32 \cdot \vert {Y}_{[ i , j ] ]} \vert + {Round}_{ [ i , j ]}}{2 \cdot {Q}_{m [ i , j ]} {Q}_{p}} ) \qquad ( 3 )$$

where Y[i,j] may be DCT transformed coefficients, Qm may be the quantization matrices coefficients, and Qp may be the quantization scale/parameter according to, for example, the ISO 13818-2 (MPEG-2). The sign(X) may be “−1” if X is less than zero, and “1” otherwise. Round_{[i,j]} may be, for example, ½(Q_{m[i,j]}).

FIG. 1D is an exemplary block diagram for coding frames using AVC technology with adaptive HVS filtering, in accordance with an embodiment of the invention. Referring to FIG. 1D, there is shown buffers 150, 156, and 174, a motion estimation block 152, a motion compensation block 154, an INTRA selection block 158, an INTRA prediction block 160, a DCT integer (INT) transform block 162, a standard quantizer block 164a, an adaptive HVS quantizer block 164b, a combining filter block 164c, an entropy encoder block 166, an inverse quantizer block 168, an inverse INT transform block 170, and a deblock filter 172. The buffers 150, 156, and 174, the motion estimation block 152, the motion compensation block 154, the standard quantizer block 164a, the adaptive HVS quantizer block 164b, the combining filter block 164c, the entropy encoder block 166, and the inverse quantizer block 168 may be similar to the corresponding blocks described with respect to FIGS. 1B and 1C.

The INTRA selection block 158 may comprise suitable logic, circuitry, and/or code that may be enabled to receive pixels from the buffer 150 and the presently reconstructed pixels where the reconstructed pixels may be the pixels from the switch 176 added to the pixels from the inverse INT transform block 170. Based on the input pixels, the INTRA selection block 158 may select an appropriate INTRA prediction mode and communicate the selected INTRA prediction mode to the INTRA prediction block 160.

The INTRA prediction block 160 may comprise suitable logic, circuitry, and/or code that may be enabled to receive presently reconstructed pixels where the reconstructed pixels may be the pixels from the switch 176 added to the pixels from the inverse INT transform block 170. The INTRA prediction block 160 may generate output pixels based on the selected INTRA prediction mode and the reconstructed pixels to the switch 176. These pixels may be selected, for example, when an INTRA frame is being encoded using AVC.

The INT transform block 162 may comprise suitable logic, circuitry, and/or code that may be enabled to provide an approximation of the DCT base functions, and the INT transform block 162 may operate on, for example, 4×4 pixel blocks. The INT transform block 162 may also, for example, operate on 8×8 pixel blocks. The inverse INT transform block 170 may comprise suitable logic, circuitry, and/or code that may be enabled to regenerate pixels similar to those provided to the input of the INT transform block 162.

The deblock filter 172 may comprise suitable logic, circuitry, and/or code that may be enabled to alleviate “blocky” artifacts that may result from compression. There is also shown a switch 176 that may enable selection of pixels from the motion compensation block 154 or the INTRA prediction block 160, depending on whether an INTER macroblock or an INTRA macroblock is being encoded. The switch 176 may comprise, for example, a multiplexer functionality that may select intra or inter coding per macroblock in B and P pictures. For I pictures, all macroblocks may be intra coded.

The buffer 150 may hold the original pixels of the current frame and the buffer 156 may hold reconstructed pixels of previous frames. An encoding method from, for example, MPEG standard, may use the motion estimation block 152 to process a macroblock of 16×16 pixels in the buffer 150 and a corresponding block of pixels from, for example, one or more previous frames, to find a motion vector for the macroblock of 16×16 pixels. The previous frames used may be the original frames or reconstructed frames. The motion vector may be communicated to the motion compensation block 154, which may use the motion vector to generate a motion compensated macroblock of 16×16 pixels from the reconstructed pixels stored in the buffer 156. These pixels may be selected, for example, when an INTER frame is being encoded using AVC.

The INTRA selection block 158 may receive pixels from the buffer 150 and the presently reconstructed pixels where the reconstructed pixels may be the pixels from the switch 176 added to the pixels from the inverse INT transform block 170. Based on the input pixels, the INTRA selection block 158 may select an appropriate INTRA prediction mode and communicate the selected INTRA prediction mode to the INTRA prediction block 160. The INTRA prediction block 160 may also receive presently reconstructed pixels where the reconstructed pixels may be the pixels from the switch 176 added to the pixels from the inverse INT transform block 170. The INTRA prediction block 160 may generate output pixels based on the selected INTRA prediction mode and the reconstructed pixels to the switch 176. These pixels may be selected, for example, when an INTRA frame is being encoded using AVC.

The pixels that may be selected by the switch 176 may be subtracted from the original pixels from the buffer 150, and the result may be referred to as residual pixels. The residual pixels may be INT transformed by INT transform block 162, where the INT transform may operate on 4×4 pixel blocks. The INT transform may be an approximation of the DCT base functions. The INT coefficients resulting from the INT transform may be quantized by the standard quantizer block 164a and the adaptive HVS quantizer block 164b. The quantized coefficients from the standard quantizer block 164a and the adaptive HVS quantizer block 164b may be communicated to the combining filter block 164c. The combining filter block 164c may output filtered coefficients that may be communicated to the entropy encoder 166 and the inverse quantizer block 168. The entropy encoder block 166 may scan the quantized coefficients in, for example, a zig-zag scan order.

The quantized coefficients may be processed by the inverse quantizer block 168 and then by the inverse INT transform block 170 to generate reconstructed residual pixels. The reconstructed residual pixels may then be added to the selected pixels from the switch 176 to generate reconstructed pixels. The reconstructed pixels may be processed by the deblock filter 172 to alleviate “blocky” artifacts that may result from compression. The output of the deblock filter 172 may be stored in the buffer 174. The reconstructed pixels may be used, for example, to process subsequent video frames.

The AVC quantization performed, for example, by the standard quantizer block 164a, may be described by the following equation:

$${QuantCoeffs}_{ [ i , j ]}^{ Xtype} = \frac{sign ( {Y}_{[ i , j ]} ) \cdot ( \vert {Y}_{[ i , j ] ]} \vert \cdot {Q}_{{m}_{[ YUV , InterIntra , Qp\_rem , i , j ]}}^{Xtype} + {Round}_{ [ i , j ]}^{ Xtype} )}{( 2 ) ( \frac{{Q}_{P}}{6} + {QBITS}^{ Xtype} )} \qquad ( 4 )$$

where Y_{[i,j]} may be integer (INT) transformed coefficients, Qₘ may be the quantization matrices coefficients, and Qₚ may be the quantization scale/parameter according to, for example, H-264/MPEG-4. The parameter YUV may indicate different quantization matrix coefficients (Qₘ) for chroma and luma components. The parameter InterIntra may indicate whether to perform INTER processing for temporal and spatial redundancy, or INTRA processing for spatial redundancy. The parameter Qp_rem may be a selector function of Qₚ of the quantization matrices coefficients (Qₘ) from, for example, a set of six possible Qₘ matrices.

The sign(X) may be “−1” if X is less than zero, and “1” otherwise. Round_{[i,j]} may be, for example, ½(Q_{m[i,j]}). The Xtype may be 4×4 pixel block or 8×8 pixel block, for example. The QBITS for Xtype of 4×4 may be 15, and the QBITS for Xtype of 8×8 may be 16, for example. The normalization of INT transform may be performed, for example, in the quantization process after the transform core operation. This may approximate orthonormal transformation.

The adaptive HVS quantizer block 164b and the combining filter block 164c may enable adaptive HVS filtering by zeroing relatively small quantized coefficients generated by the standard quantizer block 164a, while minimizing effect on significant quantized coefficients. Many of the small quantized coefficients may be high-frequency coefficients, which may affect detail, while many of the significant quantized coefficients may be low-frequency coefficients, which may affect blockiness. Accordingly, the adaptive HVS quantizer block 164b and the combining filter block 164c may perceptually enhance a displayed video by balancing blurriness and blockiness on a macroblock level.

The filtering matrices may be generated by the adaptive HVS quantizer block 164b using an adaptive quantization matrix. There may be M adaptive quantization matrices for a 4×4 pixel block, and additional N adaptive quantization matrices for an 8×8 pixel block. In an embodiment of the invention, M and N may be, for example, 6. Other embodiments of the invention may use other values for M and N. The adaptive HVS filtering may be executed with the filtering matrix generated by the combining filter block 164c, where the adaptive quantization matrix to be used may be indicated during macroblock or sub-macroblock level configuration by, for example, the image processor 112, the processor 114, and/or the logic block 118. If a coefficient generated by the adaptive HVS quantizer block 164b is a zero, then the combining filter block 164c may place a zero in place of a corresponding quantized coefficient in the quantized matrix from the standard quantizer block 164a. Otherwise, the standard quantized coefficient generated by the standard quantizer block 164a may be used. Accordingly, relatively small quantized coefficients from a quantizer block may be zeroed without impacting the significant quantized coefficients.

The adaptive HVS filtering for AVC may use, for example, an algorithm generally described by:

$$If ( {Q}_{HVS ( i , j )} == 0 ) \\ {Q}_{final ( i , j )} = 0 ; \\ Else \\ {Q}_{final ( i , j )} = {QuantCoeffs}_{( i , j )} . \qquad ( 5 )$$

Q_{HVS(i,j)} may be defined as:

$${Q}_{{HVS}_{ [ i , j ]}} = ( \vert {DCT}_{[ i , j ] ]} \vert \cdot Q mat {HVS}_{ [ i , j ]}^{ k} + {Round}_{ [ i , j ] ]}^{ Xtype} ) \text{<<} ( \frac{Q P}{6} + {QBITS}^{ Xtype} ) \qquad ( 6 )$$

where QuantCoeffs(i,j) is the output of the standard quantizer block 164a and QmatHVS is the adaptive HVS quantization matrix, Xtype indicates a 4×4 pixel array or 8×8 pixel array, and if Xtype indicates 4×4 pixel array, QBITS=15, otherwise QBITS=16. The term Q_{final} may be the quantized coefficient value after the adaptive HVS filtering process by the combining filter block 164c. Q_{final} may be delivered to the entropy encoder block 166, and also used as input for the inverse quantizer block, such as the inverse quantizer block 168. Similar methods may be used, for example, with respect to MPEG2 encoding.

The adaptive quantization matrices may be based on, for example, a tradeoff between blurriness and blockiness, and/or a number of bits needed to code a macroblock or region. The tradeoff between blurriness and blockiness may be based on, for example, a multiplication of peak signal to noise ratio (PSNR) of the original pictures and the PSNR of the reconstructed pictures. The tradeoff may comprise, for example, perceptually tuning based on test results of a group of visual observers and/or based on well known analytical tools, such as, for example, LaGrange curves optimization.

The adaptive quantization matrices may also be based on, for example, encoder target bit rate, an encoding standard of the video signals, which may comprise, for example, MPEG2, MPEG4-SP, and MPEG4-part10-AVC. The adaptive quantization matrices may also be based on whether the video signals are using INTER coding or INTRA coding, and/or whether the video signals are interlaced signals or progressive signals. The adaptive quantization matrices may further be based on quantization by, for example, the standard quantizer block 164a, input noise level, and/or a macroblock texture, which may comprise luminance and/or chrominance data for pixels in the macroblock.

The measurement of input noise level may be design and/or implementation dependent. For example, the video signal may be received as an analog input from an antenna, a cable TV connection, and/or an Internet connection. The input noise level may be expressed, for example, as a signal-to-noise ratio. The received analog signals may be converted to digital signals, and the input noise level may be expressed, for example, peak signal-to-noise ratio (PSNR). The specific algorithm used to process the digital signals to determine input noise level may be design and/or implementation dependent.

FIG. 2A is an exemplary diagram illustrating a pixel block, which may be utilized in connection with an embodiment of the invention. Referring to FIG. 2A there is shown an exemplary DCT coefficient array 200 for a block of 8×8 pixels. The DCT coefficient array 200 may be generated from video data that may correspond to a pixel block of 8×8. The following exemplary equation may be used to generate the DCT coefficient array:

$${B}_{( {k}_{1} , {k}_{2} )} = {\sum }_{i = 0}^{{N}_{1} - 1} {\sum }_{j = 0}^{{N}_{2} - 1} ( \begin{matrix}4 \cdot {A}_{( i , j )} \cdot cos [ \frac{π \cdot {k}_{1}}{2 \cdot {N}_{1}} \cdot ( 2 \cdot i + 1 ) ] \cdot \\ cos [ \frac{π \cdot {k}_{2}}{2 \cdot {N}_{2}} \cdot ( 2 \cdot j + 1 ) ]\end{matrix} ) \qquad ( 7 )$$

where the input image may be pixels in the array A that may be, for example, N2 pixels wide by N1 pixels high. B₍ₖ_{₁}_{,k}_{₂}₎ may be the DCT coefficient in row K1 and column K2 of the DCT coefficient array 200. The DCT multiplications may be real. The DCT input may be an 8×8 array of integers, where the array may comprise pixels with a gray scale level. An 8-bit pixel may comprise levels from 0 to 255. The generated DCT coefficient array 200 may comprise integers that may range from −1024 to 1023.

For most images, much of the signal energy may lie at low frequencies, which may correspond to the upper left corner of the DCT coefficient array 200. The low frequencies may affect “blockiness” of a displayed picture. The lower right values may represent higher frequencies that may provide detail for a displayed picture. However, the high-frequency values may often be small. Accordingly, neglecting these small high-frequency values may result in little visible distortion. Spatial video redundancy may now be eliminated if components with high frequency and low amplitude are ignored, and the resulting output data may be a compressed form of the original data.

Among the main properties of a DCT may be high de-correlation, energy compaction, orthogonality, symmetry, and separability. The property of separability may allow B₍ₖ_{₁}_{,k}_{₂}₎ to be computed in two steps by successive 1-D operations on rows and columns of an image. Accordingly, the Equation (7) may be expressed as:

$${B}_{( {k}_{1} , {k}_{2} )} = {\sum }_{i = 0}^{{N}_{1} - 1} ( cos [ \frac{π \cdot {k}_{1}}{2 \cdot {N}_{1}} \cdot ( 2 \cdot i + 1 ) ] {\sum }_{j = 0}^{{N}_{2} - 1} 4 \cdot {A}_{( i , j )} \cdot cos [ \frac{π \cdot {k}_{2}}{2 \cdot {N}_{2}} \cdot ( 2 \cdot j + 1 ) ] ) \qquad ( 8 )$$

The symmetry property may now reveal that the row and column operations may be functionally identical. Accordingly, a separable and symmetric transform may be expressed in the form

B=C A C^{T} (9)

where C and A may be matrices, and C^{T} may be the C transposed matrix. Accordingly, the Equation (7) may be expressed using transpose matrices only, by iterating the same matrix multiplication:

B=(A^{T}C^{T})^{T} C^{T} (10)

For the DCT coefficient array 200, a _{DC} value of 700 may be at F(0,0), and AC values may be 100 at F(0,1) and 200 at F(1,0). The remaining DCT coefficients may be, for example, zeros. Accordingly, the DCT coefficient array 200 may be encoded by specifying the values at F(0,0), F(0,1), and F(0,2), followed by an end-of-block (EOB) symbol. The particular method of arranging the coefficients may depend on a scanning algorithm used. For example, a zig-zag scan, described in more detail in FIG. 2B, may be used.

AVC technology may also operate on the input array of pixels with an INT transform. While an input array may comprise 4×4 pixels or 8×8 pixels, a description of the INT transform using an input 4×4 pixel array X is given below. Operation on the 4×4 input pixel array X, using Equation (9), may result in a DCT coefficient array Y:

$$\begin{matrix}Y = A \times X \times {A}^{T} \\ = [ \begin{matrix}a & a & a & a \\ b & c & - c & - b \\ a & - a & - a & a \\ c & - b & b & - c\end{matrix} ] \times X \times [ \begin{matrix}a & b & a & c \\ a & c & - a & - b \\ a & - c & - a & b \\ a & - b & a & - c\end{matrix} ]\end{matrix} \\ where a = \frac{1}{2} ; b = \sqrt{\frac{1}{2}} \cdot cos ( \frac{π}{8} ) ; c = \sqrt{\frac{1}{2}} \cdot cos ( \frac{3 \cdot π}{8} ) . \qquad ( 11 )$$

The matrix equation shown in Equation (11) may be factored to the following equivalent form:

$$\begin{matrix}Y = ( C \times X \times {C}^{T} ) ⊗ E \\ = ( [ \begin{matrix}1 & 1 & 1 & 1 \\ 1 & d & - d & - 1 \\ 1 & - 1 & - 1 & 1 \\ d & - 1 & 1 & - d\end{matrix} ] \times X \times [ \begin{matrix}1 & 1 & 1 & d \\ 1 & d & - 1 & - 1 \\ 1 & - d & - 1 & 1 \\ 1 & - 1 & 1 & - d\end{matrix} ] ) ⊗ \\ [ \begin{matrix}{a}^{2} & a b & {a}^{2} & a b \\ a b & {b}^{2} & a b & {b}^{2} \\ {a}^{2} & a b & {a}^{2} & a b \\ a b & {b}^{2} & a b & {b}^{2}\end{matrix} ]\end{matrix} \qquad ( 12 )$$

where C×X×C^{T} may be a “core” 2D transform, and “E” may be a scaling factor matrix that may be element-wise multiplied (\textcircled{×}) by the “core” product. The term “d” may be equal to “c/b,” however it may be approximated to 0.5 to simplify calculations. The final integer forward transform shown below may avoid divisions in the “core,” where divisions may result in loss of accuracy when integer arithmetic is used:

$$\begin{matrix}Y = ( {C}_{f} \times X \times {C}_{f}^{T} ) ⊗ {E}_{f} \\ = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] \times X \times [ \begin{matrix}1 & 2 & 1 & 1 \\ 1 & 1 & - 1 & - 2 \\ 1 & - 1 & - 1 & 2 \\ 1 & - 2 & 1 & - 1\end{matrix} ] ) ⊗ \\ [ \begin{matrix}{a}^{2} & a b / 2 & {a}^{2} & a b / 2 \\ a b / 2 & {b}^{2} / 4 & a b / 2 & {b}^{2} / 4 \\ {a}^{2} & a b / 2 & {a}^{2} & a b / 2 \\ a b / 2 & {b}^{2} / 4 & a b / 2 & {b}^{2} / 4\end{matrix} ]\end{matrix} \qquad ( 13 )$$

where a=d=½ and b=(⅖)^{1/2}. The core may be an orthogonal operation but not an orthonormal operation:

$$( {C}_{f} \times {C}_{f}^{T} ) = [ \begin{matrix}4 & 0 & 0 & 0 \\ 0 & 10 & 0 & 0 \\ 0 & 0 & 4 & 0 \\ 0 & 0 & 0 & 10\end{matrix} ] \qquad ( 14 )$$

The E scaling may be performed, for example, in the quantization process by the standard quantizer block 164a after the transform core operation by the INT transform block 162.

Accordingly, the inverse transform of Equation (9) may be given by:

$$\begin{matrix}{X}^{′} = {C}_{i}^{T} \times ( Y ⊗ {E}_{i} ) \times {C}_{i} \\ = [ \begin{matrix}1 & 1 & 1 & 1 / 2 \\ 1 & 1 / 2 & - 1 & - 1 \\ 1 & - 1 / 2 & - 1 & 1 \\ 1 & - 1 & 1 & - 1 / 2\end{matrix} ] \times ( Y ⊗ [ \begin{matrix}{a}^{2} & a b & {a}^{2} & a b \\ a b & {b}^{2} & a b & {b}^{2} \\ {a}^{2} & a b & {a}^{2} & a b \\ a b & {b}^{2} & a b & {b}^{2}\end{matrix} ] ) \times \\ [ \begin{matrix}1 & 1 & 1 & 1 \\ 1 & 1 / 2 & - 1 / 2 & - 1 \\ 1 & - 1 & - 1 & 1 \\ 1 / 2 & - 1 & 1 & - 1 / 2\end{matrix} ]\end{matrix} \qquad ( 15 )$$

FIG. 2B is an exemplary diagram illustrating zig-zag scan of a pixel block, which may be utilized in connection with an embodiment of the invention. Referring to FIG. 2B there is shown an exemplary DCT coefficient array 210 of size 8×8, where F(0,5) has a coefficient value of 2 and F(1,6) has a coefficient value of 5. The remaining coefficients may be zeros. Zig-zag scanning of the coefficients in the DCT coefficient array 210 may scan F(0,0), then F(1,0), then F(0,1). The next coefficients scanned may be F(0,2), then F(1,1), then F(2,0). The next coefficients scanned may be F(3,0), then F(2,1), then F(1,2), then F(0,3). In a similar manner, the zig-zag scanning algorithm may scan the remaining diagonals of the DCT coefficient array 210. Accordingly, the zig-zag scan may finish by scanning F(7,6), then F(6,7), then F(7,7).

The result of the scan may then be 20 zeros, the coefficient of 2 at F(0,5), 13 zeros, the coefficient of 5 at F(1,6), and 29 zeros. This encoding method may indicate the number of zeros in a sequence and the coefficient value. For example, if *N indicates N number of zeros, the zig-zag scan result of the DCT coefficient array 210 may be (*20, 2, *13, 5, EOB). Since there is no non-zero coefficient after F(1,6), the EOB symbol may indicate to a decoding entity to pad a regenerated DCT coefficient array with zeros for the remainder of the array.

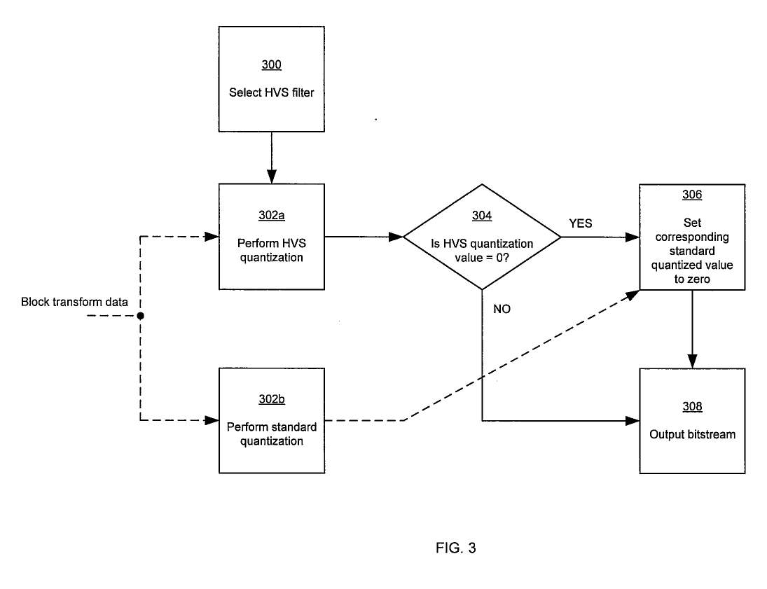

FIG. 3 is an exemplary flow diagram for using an adaptive HVS filter, in accordance with an embodiment of the invention. Referring to FIG. 3, there is shown steps 300 to 308. Although the steps 300 to 308 are described with respect to FIG. 1D, the steps 300 to 308 may also describe, for example, similar functionalities in FIG. 1B or 1C. In step 300, one of a plurality of the filtering coefficient matrices may be selected for use in the adaptive HVS quantizer block 164b. There may be, for example, 2N adaptive quantization matrices that may be available, where N adaptive quantization matrices may be for 4×4 pixel arrays and another N adaptive quantization matrices may be for 8×8 pixel arrays. Data that may be communicated to the adaptive HVS quantizer block 164b from the INT transform block 162 may be INT coefficients that may correspond to, for example, 4×4 pixel arrays.

The various adaptive quantization matrices may be generated, for example, for optimization of video taking into account various factors, such as, for example, encoding standards, INTER/INTRA coding, quantization, input noise level, macroblock texture, interlaced/progressive scan type, target bit rate, and/or video pictures resolution. Accordingly, these various factors may also be taken into account to select a particular adaptive quantization matrix that may optimize encoding of video signals.

In step 302a and 302b, the INT coefficients generated by the INT transform block 162 may be quantized by the adaptive HVS quantizer block 164b and the standard quantizer block 164a, respectively. In step 304, the combining filter block 164c may determine which coefficients of the filtering matrix generated by the adaptive HVS quantizer block 164b may be zeros. If a coefficient from the adaptive HVS quantizer block 164b is a zero, the next step may be step 306. Otherwise, the next step may be step 308. The determination may be based on, for example, an algorithm described by Equation (5) using a corresponding coefficient of the filtering matrix.

In step 306, the corresponding quantized value from the standard quantizer block 164a may be set to zero by the combiner filter block 164c. In step 308, the output of the combiner filter block 164c may be communicated to, for example, the entropy encoder block 166. Accordingly, if a coefficient output by the adaptive HVS quantizer block 164b is zero, a zero may be communicated to the entropy encoder block 166 by the combiner filter block 164c. Otherwise, the corresponding quantized value output by the standard quantizer block 164a may be communicated unchanged to the entropy encoder block 166 by the combiner filter block 164c.

In accordance with an embodiment of the invention, aspects of an exemplary system may comprise one or more processors, such as, for example, the image processor 112, the processor 114, the standard quantizer block 164a, the adaptive HVS quantizer block 164b, and/or the combining filter block 164c that enable processing of a video image. The standard quantizer block 164a may generate standard quantized coefficients. The adaptive HVS quantizer block 164b may generate filtering coefficients that correspond to the standard quantized coefficients. The combining filter block 164c may filter the standard quantized coefficients utilizing the corresponding filtering coefficients. The combining filter block 164c may enable setting of a value of a standard quantized coefficient to a zero when the corresponding filtering coefficient is zero. The combining filter block 164c may also enable utilization of a value of a standard quantized coefficient when the corresponding filtering coefficient is non-zero. That is, the combining filter block 164c may transfer the standard quantized coefficient to the entropy encoder block 166 and the inverse quantizer block 168 without any change when the corresponding filtering coefficient is non-zero.

The adaptive HVS quantizer block 164b may generate a filtering matrix that comprises the filtering coefficients using one of a plurality of adaptive quantization matrices. The adaptive quantization matrices may be pre-generated and/or generated at run time. The adaptive quantization matrices may be generated based on a texture of a portion of the video data being processed, where the texture may comprise luminance and/or chrominance of the pixels in the portion of the video data being processed. The adaptive quantization matrices may also be generated based on one or more of, for example, the video data, target bit rate, frame rate, input noise level of the video data, interlaced or progressive scan type of the video data, motion vector/s of the current macroblock or pixel block, and motion correlation to surrounding macroblocks or pixel blocks. The image processor 112 and/or the processor 114 may enable selection of an adaptive quantization matrix for generating the filtering coefficients for each macroblock or for each block within a macroblock in the video data.

Another embodiment of the invention may provide a machine-readable storage, having stored thereon, a computer program having at least one code section executable by a machine, thereby causing the machine to perform the steps as described above for an adaptive HVS filter.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for processing video, the method comprising:
generating standard quantized coefficients during processing of video data;
generating filtering coefficients that correspond to said standard quantized coefficients; and
filtering said standard quantized coefficients utilizing said corresponding filtering coefficients.

2. The method according to claim 1, comprising generating a filtering matrix comprising said filtering coefficients using one of a plurality of adaptive quantization matrices.

3. The method according to claim 2, comprising generating said adaptive quantization matrices based on one or more of: said video data, input noise level of said video data, a scan type of said video data, target bit rate, picture resolution, macroblock motion vector, pixel block motion vector, motion correlation to surrounding macroblocks, and motion correlation to surrounding pixel blocks.

4. The method according to claim 1, comprising selecting an adaptive quantization matrix based on a texture of a portion of said video data to be processed, wherein said texture comprises one or both of luminance and chrominance of pixels in said portion of said video data to be processed.

5. The method according to claim 1, comprising selecting an adaptive quantization matrix for generating said filtering coefficients for each macroblock in said video data.

6. The method according to claim 1, comprising selecting an adaptive quantization matrix for generating said filtering coefficients for each block in a macroblock in said video data.

7. The method according to claim 1, comprising setting to a zero a value of each of said standard quantized coefficients, whose said corresponding filtering coefficient is zero.

8. The method according to claim 1, comprising utilizing a value of each of said standard quantized coefficients whose said corresponding filtering coefficient is non-zero.

9. A machine-readable storage having stored thereon, a computer program having at least one code section for processing video, the at least one code section being executable by a machine for causing the machine to perform steps comprising:
generating standard quantized coefficients during processing of video data;
generating filtering coefficients that correspond to said standard quantized coefficients; and
filtering said standard quantized coefficients utilizing said corresponding filtering coefficients.

10. The machine-readable storage according to claim 9, wherein the at least one code section comprises code for generating a filtering matrix comprising said filtering coefficients using one of a plurality of adaptive quantization matrices.

11. The machine-readable storage according to claim 10, wherein the at least one code section comprises code for generating each of said adaptive quantization matrices based on one or more of: said video data, input noise level of said video data, a scan type of said video data, target bit rate, picture resolution, macroblock motion vector, pixel block motion vector, motion correlation to surrounding macroblocks, and motion correlation to surrounding pixel blocks.

12. The machine-readable storage according to claim 9, wherein the at least one code section comprises code for selecting an adaptive quantization matrix based on a texture of a portion of said video data to be processed, wherein said texture comprises one or both of luminance and chrominance of pixels in said portion of said video data to be processed.

13. The machine-readable storage according to claim 9, wherein the at least one code section comprises code for selecting an adaptive quantization matrix for generating said filtering coefficients for each macroblock in said video data.

14. The machine-readable storage according to claim 9, wherein the at least one code section comprises code for selecting an adaptive quantization matrix for generating said filtering coefficients for each block in a macroblock in said video data.

15. The machine-readable storage according to claim 9, wherein the at least one code section comprises code for setting to a zero a value of each of said standard quantized coefficients, whose said corresponding filtering coefficient is zero.

16. The machine-readable storage according to claim 9, wherein the at least one code section comprises code for utilizing a value of each of said standard quantized coefficients whose said corresponding filtering coefficient is non-zero.

17. A system for processing video, the system comprising:
one or more circuits that enable generation of standard quantized coefficients during processing of video data;
said one or more circuits enable generation of filtering coefficients that correspond to said standard quantized coefficients; and
said one or more circuits enable filtering of said standard quantized coefficients utilizing said corresponding filtering coefficients.

18. The system according to claim 17, wherein said one or more circuits enable generation of a filtering matrix comprising said filtering coefficients using one of a plurality of adaptive quantization matrices.

19. The system according to claim 18, wherein said plurality of adaptive quantization matrices are generated based on one or more of: said video data, input noise level of said video data, a scan type of said video data, target bit rate, picture resolution, macroblock motion vector, pixel block motion vector, motion correlation to surrounding macroblocks, and motion correlation to surrounding pixel blocks.

20. The system according to claim 17, said one or more circuits enable selection of an adaptive quantization matrix based on a texture of a portion of said video data to be processed, wherein said texture comprises one or both of luminance and chrominance of pixels in said portion of said video data to be processed.

21. The system according to claim 17, wherein said one or more circuits enable selection of an adaptive quantization matrix for generating said filtering coefficients for each macroblock in said video data.

22. The system according to claim 17, wherein said one or more circuits enable selection of an adaptive quantization matrix for generating said filtering coefficients for each block in a macroblock in said video data.

23. The system according to claim 17, wherein said one or more circuits enable setting of a value of each of said standard quantized coefficients to a zero whose said corresponding filtering coefficient is zero.

24. The system according to claim 17, wherein said one or more circuits enable utilization of a value of each of said standard quantized coefficients whose said corresponding filtering coefficient is non-zero.
